(19) United States
(12) Patent Application Publication
(10) Pub. No.: US 2013/0238353 A1
(43) Pub. Date: Sep. 12, 2013

(54) Method for Quantifying the Science of Medicine

(71) Applicant: Bradley Richard Hennenfent, Sebring, FL (US)

(72) Inventor: Bradley Richard Hennenfent, Sebring, FL (US)

(21) Appl. No.: 13/827,438

(22) Filed: Mar. 14, 2013

Related U.S. Application Data
(63) Continuation-in-part of application No. 13/336,596, filed on Dec. 23, 2011.

(51) Int. Cl. G06Q 50/22; G06Q 10/06

(52) U.S. Cl. CPC G06Q 50/22; G06Q 10/06
USPC 705/2

(57) ABSTRACT

Systems and methods for providing a quantification value associated with each and every medical procedure, practice, diagnosis, or combinations thereof for providing automated benchmarking for best practices and for quantifying the science of medicine.

### CROSS REFERENCE TO RELATED APPLICATIONS

This application is a continuation-in-part of U.S. patent application Ser. No. 13/336,596, filed Dec. 23, 2011, which claims the benefit of U.S. Provisional Application No. 61/426,620, filed Dec. 23, 2010, each of which is herein incorporated by reference in its entirety.

### BACKGROUND OF THE INVENTION

1. Field of the Invention

The present invention relates to systems and methods for quantifying medical practices, including diagnostic systems, treatment systems, and methods related to the practice of medicine.

2. Description of the Prior Art

It is known in the prior art to provide medical social networks and databases describing selected medical procedures, wherein using data from these databases, then models and formulas are created to calculate claim reimbursement from health insurance companies. These prior art documents also describe a risk-level rating associated with the medical procedure, which is primarily directed to insurance assessment of medical procedures. It is also known in the art to provide models and algorithms to calculate insurance reimbursement from a medical claim and risk analysis for a medical procedure. Such models for evaluating medical procedures may use a variety of data such as patient history, procedure history, experience required, success ratio and other data available through a network or database.

The following US patents and published pending patent applications are relevant to the prior art of the present invention:

US Pub. No. 20020184050 for Medical system for shared patient and physician decision-making, which describes a computerized health evaluation system for joint patient and physician decision-making concerning particular medical diseases and conditions, further including a computer system having a patient input module for patient input of patient data concerning the patient's lifestyle and preferences; a physician input module for physician input of physical and physiological data, a database of the latest medical findings concerning the particular disease and condition. The physical and physiological data includes diagnostic test results, symptom data, physical exam findings, disease progression rate, preliminary treatment plan, reaction to outcome among treatment, and patient history.

U.S. Pat. No. 7,739,128 and US Pub. No. 20060293923 for Medical claims evaluation system, teaching a method for measuring iterative medical procedures by source comprising the steps of creating a procedures database of identified medical procedures in an accessible system memory and creating a provider database by associating individual medical providers with a unique identifier in said provider database; using a patient database by associating individual patients with a unique identifier in said patient database and deriving anecdotal data from sequential medical payment claims; and determining the percentage of referenced repetitive medical procedures associated with each medical provider as a percentage of all anecdotal data of the same procedure associated with the provider and quantifying each medical provider and procedure by said percentage of repetitive medical procedures. Notably, this quantification is used for medical billing.

US Pub. No. 20020138306 for System and method for electronically managing medical information describing an online occupational medicine management system and method that allow authorized physicians, patients, employers, and insurance companies to capture, store, retrieve, and disseminate an employee's medical records from any computer having Internet access; also provides physicians with diagnosis appropriate treatment protocols that can be pre-approved by a patient's employer and/or the employer's insurance company, thus requiring monitoring only of medical treatments that fall outside of the pre-approved protocols, reducing costs, and estimating reimbursement amounts.

US Pub No. 20080201172 for Method, system, and computer software for using an XBRL medical record for diagnosis, treatment, and insurance coverage, describing a healthcare management method, comprising extracting and/or receiving or generating a medical record comprising at least clinical examination data or laboratory results and context data therefore for a patient and creating or updating an XBRL medical record comprising XBRL data fields containing clinical examination data and/or laboratory results made over a period of time and associated metadata representing attributes at the data value level based on a medical taxonomy; also teaches creating or updating comprising converting the clinical examination data and/or laboratory results into values in one or more of the XBRL data fields and creating from the context metadata and associating the metadata representing attributes at the data value level based on the medical taxonomy and forming links between and/or among at least two items selected from one or more of the categories of categories of the data fields, metadata and components associated with the data fields in the XBRL medical record. The values quantify different procedures and laboratory results.

US Pub No. 20090125348 for Methods for generating healthcare provider quality and cost rating data, which describes a computer-implemented method for generating healthcare provider quality rating data from healthcare claim records representing services provided by a plurality of healthcare providers (such as physicians or hospitals) to one or more patients includes grouping the claim records into one or more claim groups, each representing services provided to a patient by one or more providers; assigning each claim group to a responsible provider; assessing the claim records in each claim group using guidelines for the particular disease or condition and generating a compliance score for the claim group, wherein the compliance score indicates the extent to which the claim records in the claim group match the guidelines; and generating provider quality rating data for each provider using the normalized aggregate compliance score, which is used to quantify each provider based on claim records. This application further discloses that the provider quality rating data may include one or more performance categories or graphic symbols that indicate the provider's quality of treatment in comparison to an average value. Provider volume data may also be generated. A computer-implemented method for generating healthcare provider cost rating data from healthcare claim records representing services provided by a plurality of healthcare providers to one or more patients includes grouping the claim records into one or more claim groups, each representing services provided to a patient by one or more providers.

U.S. Pat. No. 6,827,670 for System for medical protocol management, teaching a treatment control system comprising an analysis interaction algorithm performed by the first computer, wherein the analysis interaction algorithm automatically evaluates and updates a patient's treatment protocol; and that the analysis interaction protocol accesses a database of standardized orthopedic treatment protocols and patient outcomes and performs comparisons of potential outcomes for a patient to be treated. The database also includes medical literature, historic data on previous patients, and updated data from current patients.

U.S. Pat. No. 5,915,241 for Method and system encoding and processing alternative healthcare provider billing, describing a system for encoding healthcare provider billing, more particularly, documenting and processing claims for payment of specific procedures by alternative therapy providers, grouped geographically and by specialty. The system employs a computer accessing three main databases for identifying, encoding and calculation of average costs of provider services. The system further describes that each provider specialty includes its own listing of treatments which are turned into RVUs (Relative Value Unit), thus establishing a sequence of treatment fees and charges

While the prior art documents referenced hereinabove are relevant to the solutions provided by the present invention, these documents appear to describe medical social network and databases describing several medical procedures, using data from these databases, models and formulas are made to calculate claim reimbursement from health insurance companies, possibly also including a risk-level rating associated with the medical procedures. None of the documents, either alone or in combination, teach, disclose or suggest the present invention as described and claimed hereinbelow.

### SUMMARY OF THE INVENTION

The present invention relates to methods and systems to quantify or rate medical practices, procedures, diagnoses, and/or studies through a web-based repository of quantitative ratings generated by the system based upon a multiplicity of inputs, including a social network of medical practitioners, including physicians, experts, nurses, healthcare providers, and medical publications and journals, research studies, a social network of patients and combinations thereof.

More particularly, it is an object of this invention to provide methods and systems for quantifying the science of medicine, i.e., to provide a quantitative value associated with medical practices and diagnoses.

It is another object of this invention to provide methods and systems for quantifying the science of medicine, i.e., to provide a quantitative value associated with medical practices and diagnoses, wherein the quantitative value is applicable as a criterion for reimbursement of medical practices including tests, medications, procedures, etc., and applicable as a benchmark for automatically measuring and tracking the quality of medical services by comparison.

Yet another object of this invention is to provide systems and methods for social network connections among physicians for the identification of the quality of medical studies, identification of benchmark practices (or best practices), and correlating the science of medicine supporting the benchmark practices for providing a quantitative value of the available science, practice, and quality of medical services.

These and other objects and aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of one embodiment of the invention.

FIG. 2 is a flow diagram of another embodiment of the invention.

FIG. 3, shown in detail in FIG. 3—Part 1 and Part 2, is an example of a working dashboard for a user to review another user's ratings of a medical study.

FIG. 4, shown in detail in FIG. 3—Part 1 and Part 2, is a dashboard of a summary of different procedures analyzed according to the present invention.

FIG. 5, shown in detail in FIG. 3—Part 1 and Part 2, is a dashboard showing a Science of Medicine Score for doing a radical prostatectomy on localized prostate cancer.

FIG. 6, shown in detail in FIG. 3—Part 1 and Part 2, is a dashboard of another summary of different procedures analyzed according to the present invention.

### DETAILED DESCRIPTION OF THE INVENTION

Referring now to the drawings in general, the illustrations are for the purpose of describing a preferred embodiment of the invention and are not intended to limit the invention thereto. The present invention systems and methods provide quantification for the science of medicine relating to any medical practice, procedure, and/or diagnosis, based upon all relevant information from a multiplicity of sources, including patient-specific data and records, test results, research publications, medical publications, case studies, insurance risk data, and social network “live” or near-real-time peer input, review or ratings, and combinations thereof. Additionally, rating by medical practitioners may be supplemented by ratings from other relevant and/or knowledgeable raters including experts having a scientific background, engineers, technologists, medical students, students in other health fields, lawyers, bureaucrats, statisticians, and patients too.

While it is known in the prior art to provide models for evaluating medical procedures that may use a variety of data such as patient history, procedure history, experience required, success ratio and other data available through a network or database, none of the prior art references teach or disclose, either alone or in combination, systems and methods for providing a quantification value associated with each and every medical procedure, practice, diagnosis, or combinations thereof. The present invention in its various embodiments provides systems and methods for providing a quantification value associated with each and every medical procedure, practice, diagnosis, or combinations thereof for providing automated benchmarking for best practices and for quantifying the science of medicine.

The present invention provides automated systems and methods that transform qualitative information and data into a quantitative value that corresponds to a medical procedure, practice, or diagnosis, wherein the quantitative value is unique for that specific procedure, practice, diagnosis, or combination thereof. In preferred embodiments of the present invention, the quantitative value is generated from a multiplicity of factors, including research publications, case histories, patient records, tests; peer rating of research publications, procedures, and diagnoses; social network “live” rating inputs for specific case(s); and combinations thereof.

Preferably, a medical database is provided in a server computer or “cloud-based” system including medical information used to provide remote access to users of the system via distributed network to allow authorized physicians, patients, employers, and insurance companies to capture, store, retrieve, and disseminate any medical records from any computer having access to the system, such as via the Internet and secure login via unique user identification and password combination, Personal Identification Number (PIN), biometric identification, and combinations thereof.

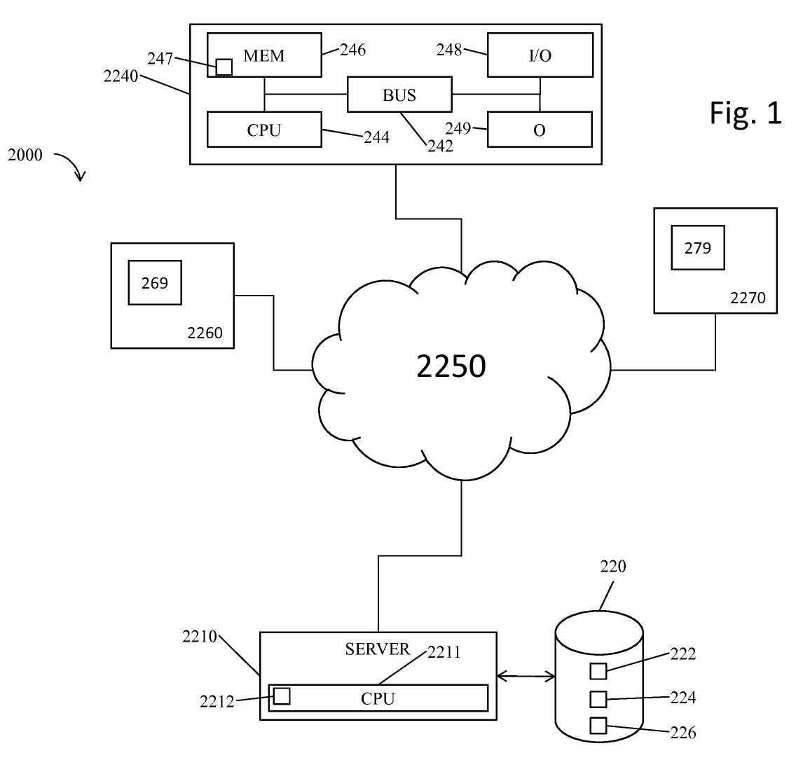

Preferably, a virtual network or cloud-based system is provided in support of a distributed network for accessing the medical database by a multiplicity of remote users, including but not limited to authorized physicians, patients, employers, and insurance companies, etc. as illustrated in FIG. 1.

FIG. 1 is a schematic diagram of a networked system and remote server computer associated with the systems and methods of the present invention. As illustrated in FIG. 1, a basic schematic of some of the key components of the system including at least one remote server computer and network access to the system, according to the present invention are shown. The system 2000 is illustrated with a server 2210 having a processing unit 2111. The server 2210 is constructed, configured and coupled to enable communication over a network 2250. The server provides for user interconnection with the server over the network using a personal computer (PC) or other network device 2240 positioned remotely from the server. Furthermore, the system is operable for a multiplicity of remote personal computers or terminals or network devices 2260, 2270. For example, in a client/server architecture, as shown. Alternatively, a user may interconnect through the network 2250 using a user device such as a personal digital assistant (PDA), mobile communication device, such as by way of example and not limited to a mobile phone, a cell phone, smart phone, laptop computer, netbook, a terminal, or any other computing device suitable for network connection. Also, alternative architectures may be used instead of the client/server architecture. For example, a thin client system or other suitable architecture may be used. The network 2250 may be the Internet, an intranet, or any other network suitable for searching, obtaining, and/or using information and/or communications. The system of the present invention further includes an operating system 2212 installed and running on the server 2210, enabling server 2210 to communicate through network 2250 with the users thereof. The operating system may be any operating system known in the art that is suitable for network communication. Additional software specific to the Science of Medicine (SOM) quantitative value generation based upon inputs, selections, and/or profiles of the user(s) or specific medical procedures, practices, and/or diagnoses.

In systems according to the present invention, a system for providing automated rating of the science of medicine includes the following: a network-based computer system including at least one server computer in communication with a multiplicity of remote devices providing access to data stored within the at least one server computer, wherein the at least one server computer is operable with software active thereon, the software transforming qualitative and quantitative information on medical procedures to a unique quantitative science of medicine (SOM) rating. Preferably the system further includes online, remote access for authorized medical practitioner users and patients for initiating an inquiry into the remote server(s) database or repository of SOM ratings for a predetermined listing of medical procedures, practices, diagnoses, and combinations thereof.

Importantly, the qualitative and quantitative information on medical procedures is transformed into a single, unique quantitative SOM rating based upon the following factors: a) whether or not at least two peer review studies exist that support the medical procedure; and b) ranking by a social network of medical practitioners based upon their clinical experience.

In embodiments of the present invention, systems and methods including medical practitioner ranking inputs stored in a data repository at the remote server computer(s) provide for the medical practitioner ranking to be weighted such that the most recent inputs are considered the most important and have greater influence on the overall ranking. It is preferred that these inputs are provided in near real time to the inquiry by any remote user, i.e., less than about five years prior to the inquiry. This is a significant difference from any prior art, since medical journals and/or publications are considered in the SOM rating along with the medical practitioner ranking to transform all inputs into a single quantitative SOM code, percentage, or value. Medical journals, research publications and the like, especially when they have been under peer review, take many years to finalize and publish. However, they also offer important data-backed research and conclusions regarding medical procedures, practices, etc. And so the combination of such highly credible references along with “near real time” inputs from medical practitioners based upon their relevant clinical experience by the system to transform the qualitative and quantitative information into a single quantitative value is highly beneficial for including credible references along with timely input from actual practice. Also, preferably, the ranking by a social network of medical practitioners based upon their clinical experience includes inputs within less than about two years prior to the inquiry, and more preferably, within less than about one year prior to the inquiry. Furthermore, beneficially, the system provides the ranking by a social network of medical practitioners based upon their clinical experience includes inputs in near real time from the inquiry.

The SOM rating is selected from SOM codes, percentages, ranking, and combinations thereof. The SOM rating is output as an answer by the system, in response to an inquiry by a remote user accessing the system, the answer including automatically generated listing of best practice(s). And more preferably, the listing of best practice(s) is provided in a ranked order from best or highest quantitative value to lowest, i.e., highest SOM rating to lowest.

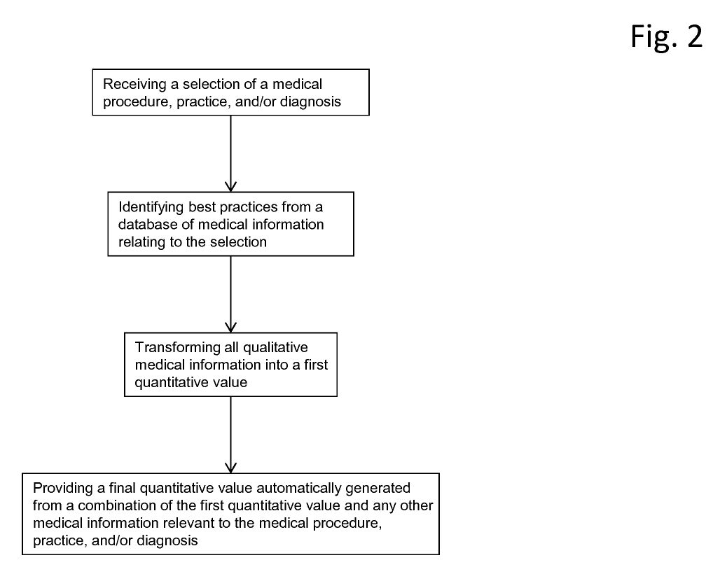

In methods of the present invention the following steps are included, and illustrated in FIG. 2: providing a network-based computer system including at least one server computer in communication with a multiplicity of remote devices providing access to data stored within the at least one server computer, wherein the at least one server computer is operable with software active thereon for performing the steps of: receiving a selection of a medical procedure, practice, and/or diagnosis; identifying best practices from a database of medical information relating to the selection, wherein the medical information includes qualitative medical information and quantitative medical information; transforming all qualitative medical information into a first quantitative value that corresponds uniquely to the medical procedure, practice, and/or diagnosis; and providing a final quantitative value automatically generated from a combination of the first quantitative value and any other quantitative medical information relevant to the medical procedure, practice, and/or diagnosis, thereby providing an integrated, unique quantitative benchmark for best practices for a specific medical procedure, practice, and/or diagnosis. Preferably, the methods further include the step of generating the first quantitative value from a multiplicity of factors, including research publications, case histories, patient records, tests; peer rating of research publications, procedures, and diagnoses; and/or social network “live” rating inputs for specific case(s).

In one embodiment of the present invention the final quantitative value is based upon a scale of zero to 100, and is used as a treatment code for automatic comparison to a benchmark value, thereby assisting physicians and patients in decision-making regarding a course of action for medical treatment, and also providing a weighted data-based factor for determining insurance reimbursement level based upon the treatment code, i.e., the higher the number (0-100), the higher the quality of the procedure and therefore the higher insurance reimbursement amount. Thus, advantageously, insurance reimbursement for medical procedures is determined in advance, and based upon quality of medical procedure or practice for a given diagnosis or condition.

Also, advantageously, while CPT codes are available for many procedures, there are also many medical procedures without CPT codes established yet. The methods and systems of the present invention provide automatic generation of a unique quantitative value for each and every procedure based upon the criteria used by the rating server and software, and accessible remotely by medical practitioners, including physicians, nurses, physician assistants, medical technicians, and the like, as well as patients, and other authorized users.

In another embodiment of the present invention, systems and methods automatically generate three related quantitative values that are uniquely associated with a given medical practice, procedure, or diagnosis; those three related quantitative values are a Science of Medicine (SOM) percentage, a SOM score (or rating), and a SOM number or code, which may be used alone or in combination as outputs from the rating computer (remote server computer and software) available via the network for authorized user(s) accessing the rating computer from remote network devices, which may include, by way of example and not limitation, computers, smart phones, network or internet access devices, etc.

In one example, the SOM percentage relating to any specific medical practice can range from 0 to 100%, and in some cases, the percentage can be negative—meaning that the harm outweighs the benefit. By way of illustrative example, if doctors were doing frontal lobotomies on patients with breast cancer, which makes no sense at all, the Science of Medicine percentage for that would be −100% (negative 100%).

Advantageously, the SOM values, either percentage, rating, or code, provide a clear, concise, and unique quantitative value for any given procedure that is automatically generated by the system and methods of the present invention based upon the medical social network's best medical advice based on the best medical literature available at the time of the inquiry to the system, and in the most easily grasped format possible (a single, unique value representing comparison to best practices, i.e., the best option for treatment under the totality of circumstances and information available). More specifically, the core of the algorithm used by the systems and methods of the present invention provide is a minimum of two high quality, independently generated, randomized controlled studies that support a medical practice, procedure, and/or diagnosis for the system to automatically generate a Science of Medicine percentage related to it at 100%. Furthermore, the SOM percentage represents access in real time to the most secret “inside medical information” possible, since it includes the advice of all physicians together through a social network, all providing inputs on how effective, safe and/or appropriate a medical practice actually is, based upon experience, knowledge, etc. And by finding the best studies, and by sorting and sifting the data based on demographic information to remove biases, the output is the most objective number possible.

In other words, the SOM percentage is a way of summarizing the hardest available data from studies, however subjective and incomplete they may be, into the most objective and easily understood format possible, and generated automatically by the system as a value, designed to separate fact from fiction to the fullest extent possible, provided by experts who are trained to do exactly this sort of thing. Preferably, a multiplicity of physician users access the system, either at their own direction or they are automatically contacted based upon their user profiles stored in the database; each of the physician users who are actively rating a select procedure, practice, and/or diagnosis will provide inputs that are saved on the remote server computer(s) in connection with a given case, which may be anonymized to protect patient privacy data. The SOM percentage generated by the system is the most objective number based on the medical literature, despite the fact that not enough studies have been done or imperfect studies have been done. Thus it is a percentage that uses the physician's skill at evaluating the medical literature to come up with the most accurate SOM percentage possible.

To some degree the SOM percentage is a gestalt number because there will be many situations where not enough studies, or not enough good studies have been done. But the percentage is to be based as much on the documented medical literature as possible. Physicians do this kind of thing all the time; they make difficult decisions based on incomplete data virtually every day of their lives. Here they will make difficult ratings, as best they can, based on the published medical literature, although in the end there is always incomplete data. It is a goal is to generate the SOM percentage as close to the actual hard data as possible, i.e., to provide the most objective and quantitative accurate ranking for any given procedure, practice, etc. The SOM percentage will be contrasted with physicians' Clinical Experience (CE) percentage, which will be based on their actual experiences practicing medicine.

By way of example, a urologist may rate the Science of Medicine percentage for doing a radical prostatectomy for localized prostate cancer very high based on their clinical experience because after doing surgery on men for prostate cancer, very few of those men ever come back to them with metastatic cancer. However, it is evident that the urological literature says the Science of Medicine percentage is very low for this operation. That's why it is important to compare both numbers, and to consider when bias, such as observer bias, is becoming a factor. Similarly, a cardiologist might rate the Science of Medicine percentage for doing cardiac stents for reducing the risk of heart attack low based on the medical literature, but might rate their Clinical Experience percentage much higher, as sometimes cardiologists see an immediate euphoria or improvement in patients after stents as the blood flow is improved, yet the controlled results in the medical literature are not nearly as encouraging. In the case wherein the rating physician has no clinical experience with the medical practice being rating they would indicate “NA” that it is not applicable to them.

As of the date of the present invention, peer review of medical studies is done by a handful of physicians who typically work for medical journals, which may allow for some bias to invade objectivity. For example, The New England Journal of Medicine and JAMA have repeatedly published opinion articles in support of socialized medicine. Just having this political philosophy may cause bias to creep into the peer review process. Yet, this type of peer review, done by a small number of editors at a journal, is the prior art benchmark for the acceptability of a medical study. This teaches away from the present invention, which provides for at least two peer review medical studies in order to realize a high quantitative value for the SOM percentage, rating, or code, or combination thereof. The present invention provides for an increased or higher quality benchmark because it allows review by a very large group of physicians in near real time through a network and being remotely distributed from each other, and therefore effectively removing their biases. So then this method provides a way to do a more rigorous, second level, of peer review, and by using the SOM database to remove biases you can get a third level of peer review. It may be worthwhile to make participating in this higher level of peer review part of the Continuing Medical Education process, and part of the requirement for renewing licenses, although it is not a requirement of the present invention as claimed.

Regarding the medical social network, ideally every medical practitioner, including physicians, around the world would be part of the Science of Medicine Social Network (SOM SN); however, practically, at least a multiplicity of licensed physicians from a diverse area of specialization or practice is preferred. The more physicians, the better, including retired physicians, as they no longer have a financial stake in the game. Some biases include, by way of example and not limitation, placebo effect, deference or respect for authority over data, lack of appreciation for detrimental side effects, lack of empathy, economic pressures, social pressures, and other internal and external pressures, and combinations thereof. Additionally, the present invention provides for medical practitioners, experts, nurses, healthcare providers and the like participating in the social network.

In another embodiment of the present invention, the SOM social network physician users or participants will also be encouraged to write original new medical review papers on medical practices using the most highly rated and most relevant medical studies as determined by the Science of Medicine Social Network (SOM SN). These reviews can also be rated and sorted by date, ratings, or relevance to the medical practice.

Medical practitioners would also be free to write opinion papers based on their clinical experience, and encouraged to publish “case reports,” as case reports are the springboard for new research hypotheses. These reports can also be rated.

The participants will also be encouraged to write original new medical review papers on medical practices using the most highly rated and most relevant medical studies as determined by the Science of Medicine Social Network (SOM SN). These reviews can also be rated and sorted by date, ratings, or relevance to the medical practice. Physicians would also be free to write opinion papers based on their clinical experience. Physicians would also be encouraged to publish “case reports,” as case reports are the springboard for new research hypotheses. These reports can also be rated.

Additionally, and optionally, the written contributions may include essays by physicians about treating patients, or about any subject, such as medical editorials, or editorials on other subjects. Poems will be a category too. This allows the SOM SN to rate these writings so that good writers will rise to the top and be available for other purposes, especially as writers for our profession.

By way of historical example, consider the frontal lobotomy procedure, which began in the 1930s and was flourishing in the 1940s and 1950s. As one of ordinary skill in the art will appreciate, it is a type of brain surgery where the frontal lobes of the brain are destroyed. Dr. Egas Moniz, a Portuguese physician actually won the Nobel Prize in Medicine for inventing the operation. That Nobel Prize looks ridiculously stupid in retrospect. At first they drilled holes in the head and destroyed some brain tissue by injecting alcohol. At times simple knives were thrust into the brain. Later, they placed a retractable wire loop inside the brain and rotated it to destroy brain tissue. It was barbaric. The front of the brain is very important to us human beings. It's used for high level thought, helps us to make choices, to make predictions, and gives us our personalities. The frontal brain essentially makes us human. Dr. Moniz, the inventor of the lobotomy, and a colleague, operated on 20 patients with depression, schizophrenia, panic disorder, mania, catatonia, and manic-depression in the 1930s and published their results in 1936. They claimed that 35% of the patients improved greatly, 35% improved moderately and that in 30% there was no change. This is a perfect example of the kind of vested-interest observer bias the quantification of the Science of Medicine is designed to stop. As you might imagine, the frontal lobotomy was highly destructive to patients, yet, if you examine the medical literature at that time, which was mostly written by surgeons who profited from the operation, the literature was glowing, and focused on improving the technique, while avoiding any kind of controlled study being done. Side effects were seldom emphasized. President John F. Kennedy's younger sister Rosemary suffered from mental retardation and violent mood swings and her father Joe Kennedy had her undergo a frontal lobotomy in 1941, unbeknownst to her mother Rose. Reportedly, the operation left her with permanent urinary incontinence and unintelligible speech. This method will stop this kind of travesty. QUESTION: What was the Science of Medicine for doing the frontal lobotomy on patients with psychiatric problems? According to doctors who did the procedure at the time the Science of Medicine was 70%. Other doctors, however, began to write in opposition of the frontal lobotomy; these were often doctors who had known patients before the operation and saw them again after the operation. But the tremendous biases of the physicians promoting the frontal lobotomy won out for over two decades. ANSWER: The SOM percentage for doing the frontal lobotomy on patients with psychiatric problems is −100%, that's negative 100%! It always harmed the patient, but essentially never did them any good. It only succeeded, according to the harshest critiques, of turning them into vegetables—doing more harm than good. Examples like these are why the SOM systems and methods of the present invention are so important.

Tuberculosis (TB) was described by Hippocrates in 460 B.C. It has killed millions of people and still does; it actually killed 1.7 million people in 2009 Pulmonary tuberculosis, also called consumption, results in fever, coughing up blood, wasting away, and death. Tuberculosis is caused by a bacterium called Mycobacterium tuberculosis. In 1943, streptomycin, a new antibiotic was discovered. Previous antibiotics such as pyocyanase and lysozyme worked in the laboratory but were too toxic to even consider using them for human beings. Streptomycin worked in petri dishes and in laboratory animals, but was also toxic to humans. It causes side effects such as permanent dizziness, hearing loss, or kidney damage in a percentage of patients. The risk of permanent disability from taking streptomycin was very real. In the 1940s there was a huge argument over the SOM of giving a toxic antibiotic like streptomycin to patients with pulmonary tuberculosis. Some people thought the Science of Medicine was greater than zero, while others, who had seen the horrible side effects from it, thought the Science of Medicine for taking it was actually negative. One clear fact was that people with pulmonary tuberculosis died more than 25% of the time. QUESTION: What is the Science of Medicine for taking streptomycin for pulmonary tuberculosis to prevent death? The first randomized controlled trial in medical history was done in Britain, and published in 1948, just to answer this question. The statistician was Austin Bradford Hill, who was later knighted for his work. It was a double-blinded study as neither patients nor doctors knew who got the streptomycin and who did not. At the end of the study 27% of the people with tuberculosis died in the control group of patients, while only 7% of patients died in the streptomycin-treated group. ANSWER: Back then, the Science of Medicine for taking streptomycin for pulmonary tuberculosis to prevent death was 20% based on this one study. When one considers later studies, and factors in the harmful side effects, the Science of Medicine (SOM) for giving streptomycin dropped to 15%.

If all doctors and patients at the time knew that the SOM number was only 15% for streptomycin saving your life, yes, people would have still taken the medicine, but the need to look for something better would have been abundantly clear. Rapid attempts would have been made to separate the patients into groups: those most likely to benefit and those most likely to be harmed. The SOM number would also be a great starting point for giving informed consent. Today, this medication would no doubt be banned for this use by the FDA. However, with the present invention, it does not ban treatments completely, but leaves the decision up to the patient and doctor, and makes it clear that since the SOM number is so low, reimbursement for the medication by any insurance plan will be low, thus discouraging the use of medical practices with low Science of Medicine percentages and encouraging the development of better treatments. Complete bans kill innovation. Complete bans also kill patients who are willing to take the risks involved. Making ineffective treatments the standard of care—or Gold Standard—also kills innovation. What pushes innovation is everyone knowing the cold hard science. Fortunately, that era was a time of antibiotic discovery and six new anti-tuberculosis antibiotics would be invented in the 1950s. Most importantly, it was demonstrated that randomized controlled double-blinded studies give you the truth. A great deal of misinformation was settled by this study, changing history.

One of the worst abuses in medical history occurred even after the randomized controlled study had been recognized as the “Gold Standard” for Western medicine, and the entire sordid episode could have been prevented by this method. Doctors started doing unnecessary hysterectomies in the 1950s. Hysterectomies, which are the removal of the female uterus with or without the ovaries, became an epidemic in the USA. This was largely blamed on the profit motive of doing surgery, as well as paternalistic male attitudes. This bad episode in medical history helped to spur the feminist movement and the women's health movement of the 1960s. The hysterectomy is major surgery and thus the reimbursement for it was also “major.” Yet, the reasons given for doing the surgery were often unjustified. The stated reasons for doing hysterectomies are treating cancer, fibroids, abnormal vaginal bleeding, pelvic pain, for contraception, and doing it prophylactically to prevent ovarian or uterine cancer. Often these things did not make any sense at all. For example, there was clearly a time when the risk of dying from a hysterectomy was greater than the risk of dying from uterine cancer, yet the operation was done anyway. The side effects of a hysterectomy can be major—death, infection, bleeding, sexual dysfunction, and depression. The risk of death is around ½ percent. Urinary fistulas—abnormal connections—of the bladder to the vagina, or of the ureter to the vagina also occur. This means the woman leaks urine out of the vagina. Post-operative fistulas of the rectum to the vagina can also occur. This means the woman leaks stool out of her vagina. These kinds of post-surgical side effects were often underreported in medical statistics. This is a reason why patient input into the Science of Medicine percentage would be very important. Patients, who have to live with these kinds of side effects often rank side effects as being far more serious than doctors do. Besides profit, sexism played a role. Most gynecologists at the time were men so chauvinism and misogyny occurred. Sometimes the male doctors' attitude was if you are not going to have children you don't need a uterus. Physicians told women that the operation would not affect their sexuality and if it did, it was psychological—their fault—and had nothing to do with the surgery. But sexual dysfunction was caused by the surgery. Hysterectomies can destroy hormone production, decrease lubrication, remove the possibility of an internal orgasm, and decrease sensitivity of the clitoris. Male doctors also treated women with a paternalistic attitude, telling them what to do instead of explaining all the options. The very word hysterectomy derives from the Latin hystericus, which is essentially defined as a neurotic condition of women related to them having a uterus. Studies found that male physicians were more willing to operate on women than upon themselves and that they were treating women like children, withholding information they thought might be “too much” for them. The major health insurance companies at the time were accidentally encouraging unnecessary hysterectomies because they were tending to pay for surgical and in-patient care much better than outpatient care. The Insurance Companies never would have made that mistake if the Science of Medicine behind hysterectiomies had been quantified at that time.

The hysterectomy epidemic was the perfect storm of greed, bad attitudes, unwise reimbursement policies, and lack of science. It's an excellent example of why biases need to be removed, because a surgeon's judgment can be impaired by indoctrination, biases, and self-interest. The SOM systems and methods of the present invention would have stopped this sad episode in American medical history. By 1970 over 4,000 studies had been done (Medline) that related to the hysterectomy, but no randomized controlled studies had been done. This allowed physicians to say anything they wanted to women about the need for the hysterectomy as the poor quality available data was open to wide variations in interpretation. For example, some physicians would tell women with fibroids of the uterus that they “had a tumor on the uterus” and this would scare them into thinking they had cancer, even though a fibroid tumor is benign 99.5% of the time. The poor science continues today; it needs to be fixed. QUESTION: What is the Science of Medicine percentage for a doing a hysterectomy on the average woman no longer wanting children with the average sized fibroid with average symptoms? ANSWER: 10%. Yet, because patients have no idea of how low the SOM percentage actually is for doing a hysterectomy for the average symptoms, they are easily talked into an operation which is not very scientific, instead of alternatives such as medical therapy or embolization, which may cost less, and be much safer for the patient. QUESTION: What is the Science of Medicine for doing a hysterectomy on the average woman no longer wanting children with LARGE fibroids and serious vaginal bleeding? ANSWER: 80%—based on the best medical studies today.

The algorithms that provide for the automated systems and methods of the present invention provide that doctors are networked and their demographic information is collected so that biases can be removed when necessary. For physicians, data collected would include such data as the state they live in, medical school they attended, residency they attended, current hospital affiliations and so on. Anything that could cause bias should be collected as demographic data.

The medical practitioners are presented with a question about a medical practice such as: What is the Science of Medicine for giving medication A to patients with diagnosis Z? The systems and methods of the present invention provide an online, remote access for initiating an inquiry into the remote server(s) database or repository of ratings or SOM codes, percentages, or ranking, or combinations thereof; after making a selection of a procedure, practice, diagnosis, etc., the system automatically provides the best practice in a ranked order from best or highest quantitative value to lowest.

Medicine is a great field for this method because you can have one specialty looking over the shoulder of another. This will help to remove biases and vested interests from the results. Whenever data is interpreted, you need unbiased highly educated people to weigh in. Sometimes this is the only way to remove the biases and indoctrination of an entire industry. A general point of this method is that when you removed the vested interests you will get better ratings. Doctors doing operations also rating operations for reimbursement is a conflict of interest. It is possible that a large group of physicians could attempt to rate in a dishonest fashion because they are extremely well reimbursed for some medical practice that is not scientific. This SOM SN is designed to prevent such occurrences by allowing sorting of results based on demographic data and possible conflicts of interest.

Participants in the database might be asked to sign or follow an oath that they will make ratings based on reason, logic, and science, utilizing the medical literature to the best of their ability, and that they will do their best not be biased or corrupted by money. They will agree never to “sell” their ratings. They might want to also agree to practice medicine based on reason, logic, and science, while taking into account the physical as well as emotional needs of their patients.

The medical practitioners can give their Clinical Experience percentage for the medical practice at hand first, as it requires no review of the literature, but is simply what they believe based on their experience and training to date. Physicians who do not have enough clinical experience with the medical practice do not need to give a percentage.

If necessary, for emergency situations, the systems and methods of the present invention are initially set for defaulting the Science of Medicine number to 75%, 50%, 25%, or 0%, also where a lack of studies, information, or experience-based input is available, until the Science of Medicine is known. Alternatively, there could also be an emergency panel for emergency situations.

Medical practitioner raters begin by rating studies for their relevance to that question. Next, they rate the studies for their overall quality. As more ratings are done, the most relevant studies of the highest quality are presented at the top of the list for all physicians to review while answering the question at hand. As part of rating the overall quality of a study, the raters may be asked to mark the characteristics of the studies. They are asked to go through a checklist for each study. Is it randomized? Is it controlled? Is it prospective? Is it retrospective? How many patients were studied? Is the effect being studied large or small? Forcing the raters to mark the characteristics of the study, before they rate the overall quality of the study, would probably be a valuable reminder of the study's characteristics and how those features relate to quality.

Preferably, each rater will be rated as a rater of the SOM percentage, etc., and some of the third parties that use the SOM percentages from the database, may want to limit their results to the most highly rated raters only. The way the third parties sort the database information based on the demographic information and ratings will be up to them. Basically, when it comes to this database, everything that can be rated will be rated.

Prior art has tried to come up with ways to rate journal articles. One is to rate them on their impact, for example, showing how many times an article has been cited in other studies. Rating for impact may be a factor in systems and methods of the present invention, including a sorting system, or output presentation as well. There are search engines for “Journal Impact Factor” and “Author Impact Factor.” So then the SOM SN also may provide this data in up-to-date fashion for each physician rater. However, these methodologies are far from perfect, and so the SOM SN will provide with better ratings than these “impact ratings”, in particular since SOM SN outputs a qualitative value, rating, percentage, code, etc.

Every possible tool should be used to help rate the quality of medical studies. All public domain scoring systems to help evaluate studies and all those for which permission can be obtained should be used as tools when appropriate. For example, The Jadad Score is widely used.

The Jadad questions (paraphrased) are:

1. Is the study randomized?
2. Is the study double blind?
3. Is there a description of withdrawals and dropouts?
One point is given for each yes answer. To receive additional points “yes” answers must be given to these two questions:
4. Was the method of randomization was described in the paper, and was that method appropriate?
5. Was the method of blinding described, and was it appropriate?

Points would be deducted if: The method of randomization was described, but was inappropriate or if the method of blinding was described, but was inappropriate. A randomized clinical trial could get a Jadad score of 5 if it was of the highest quality. As reviewers sit down to rate medical studies they should be given this tool to use as well as other tools like it.

There is also a longer checklist by Kenneth F. Shulz et al. that appears to be in the public domain for evaluating randomized controlled trials: http://www.plosmedicine.org/article/info:doi/10.1371/journal.pmed.1000251. This tool should also be utilized within the SOM SN, as should any others like it.

In fact existing checklists, and checklists developed by the SOM SN should be used for every type of medical study as part of the evaluation process when possible. These could be pop-up tools. Each medical practitioner will be asked to give their Clinical Experience rating for each medical practice (CE percentage.) Each medical practice can have variations, co-morbidities or other situations such as age and sex can be added.

Next, based on the medical literature, each physician gives as objectively as possible, the Science of Medicine percentage behind each medical practice. The SOM percentage of all raters is averaged using all the standard formats such as mean, median, mode, geometric mean, and logarithmic mean, etc., and third party users will have the ability to remove outliers and raters based on demographic data. Other statistics can be provided as requested or suggested so that as many functions and manipulations can be done with the database as wanted.

SOM SN further includes a visible scale for where studies fall on the spectrum from 0 to 100%. For example, randomized controlled trials (RCTs) could go from 1% to 100% depending on the number of patients. Perhaps controlled prospective studies could go from 1% to 95% depending on the number of patients. If the SOM SN developed such a scale it would help to give a visual guide to rating the quality of studies, and ultimately to rate the medical practices.

There will occasionally be a situation with special circumstances where there is no science but everyone believes a medical practice to be scientific. The present invention provides for this with a Special Circumstances percentage. Women with ectopic pregnancy often die. The CE percentage for surgery might be 100%. The SOM percentage for surgery might be 70%. The Special Circumstances percentage for this surgery might be 90% simply because it's a situation where the risk to do proper studies is great.

The first guideline is that a medical practice, to be rated 100% scientific, should have two independently done, high quality, randomized controlled trials (RCTs) supporting it. Since most RCTs are less than perfect in quality, it is expected that most medical practices with two high quality independently done RCTs supporting it would be rated in the 90 to 100% range. The second hard guideline is that any medical practice that has no studies or data supporting it would be rated 0 percent. The third hard guideline is that a medical practice that is net harmful to the patient would be rated with a negative percentage. The fourth hard guideline is that a medical practice with what is considered “average scientific evidence” behind it would be rated 50%. The fifth hard guideline is that a medical practice that only has one case report supporting it, has to be rated very low in most cases, 5% or less.

If two high quality randomized controlled studies can give you a Science of Medicine percentage of up to 100%, what would be the next best situation? Perhaps the next best situation would be one randomized controlled study and one or more large prospective studies that support the medical practice. Perhaps that is the situation required to rate something 80 to 90%. If this is used, then any medical practice that does not have one or more randomized controlled studies supporting it has to be rated <80%. But again, preferably, this is not a hard rule. There are too many variations in the quality of such studies. Thus, SOM SN guidelines are preferred, rather than a hard rule in this case.

After the first three hard criteria: two RCTs to achieve 100%, practices with no data are rated 0%, and things that cause net harm to the patient get negative percentages, it is very difficult to come up with rule that cannot be violated. This is why the fourth linchpin of the automated systems and methods of the present invention provides that the Science of Medicine Social Networks (SOM SN) develops new methods for rating studies, and methods for rating the SOM percentage, and physicians describe their methods for coming up with ratings, and those methods are rated, until the best methods for rating the quality of studies and the SOM percentage rise to the top and can be used as reference articles for all the raters.

After the first three hard criteria: two RCTs to achieve 100%, practices with no data are rated 0%, and things that cause net harm to the patient get negative percentages, it is very difficult to come up with rule that cannot be violated. This is why the fourth linchpin of the algorithm is that the SOM SN comes up with new methods for rating studies, and methods for rating the SOM percentage, and physicians describe their methods for coming up with ratings, and those methods are rated, until the best methods for rating the quality of studies and the SOM percentage rise to the top and can be used as reference articles for all the raters.

Regarding examples for exceptions, consider the following: SOM percentage is preferably ranked as having “special circumstances” for things like pulse oximetry monitoring during surgery. The database can keep track of how many times a SOM percentage is marked as having special circumstances and sometimes a modified SOM percentage can be used in such situations. This is the Special Circumstances percentage (SC percentage). For example, pulse oximetry to keep track of oxygen saturation in the blood is a common practice in anesthesia, being used virtually 100% of the time. It is cheap, easy, and does not harm the patient, but provides a warning system if the patient might be doing poorly. However, there are no randomized controlled trials clearly supporting its use because of the “obviousness” of its benefit. If enough physicians within the specialty of anesthesiology flag the situation as special, and if enough physicians outside that specialty concur with the essays posted, that medical practice should be given a special circumstances percentage as well as the regular SOM percentage, which is based on the medical literature alone.

The systems and methods of the present invention, by leveraging SOM SN are designed to harness the collective intelligence of physicians and other experts. Research has shown that no one person or panel of people can keep up with the rate of change of technology or science. Mass collaboration is needed to do this. You see this phenomenon in the “open source” software movement. It's been found that mass collaboration can reduce costs. For example, this SOM SN could replace thousands of medical boards and panels that are already trying to make these decisions for corporations and governments but are hopelessly overwhelmed. A huge group of physicians can process the ever-expanding medical literature and come to conclusions far more rapidly than small panels can.

Advantageously, aspects and embodiments of the present invention provide the following benefits, which have been longstanding, unmet needs in the medical profession and to the general public accessing medical procedures and services:

1. It creates a social network and database.
2. It organizes the medical literature by quality and relevance for each medical practice; essentially, a new method of peer review. It allows variations for each medical practice such as adding co-morbidities and techniques to be incorporated.
3. It creates new statistics called the Clinical Experience percentage, the Science of Medicine percentage, and the Special Circumstances percentage.
4. It removes biases by giving the ability to filter the Science of Medicine percentage statistic based on the demographic data and vested interests of the raters.
5. It enables the Science of Medicine (SOM) percentage, CE percentage, or SC percentage to be tied to reimbursement.
6. The SOM percentage can be used for many other things such as informed consent, education, research, and innovation.

Step by Step Instructions for the Quantification of the Science of Medicine

Introduction

The problem is that there is no unbiased “product transparency” in healthcare for patients, physicians, and healthcare providers. Everyone agrees that a need exists to empower patients with knowledge. A need also exists to empower healthcare providers so that healthcare distribution can be more efficient.

Dr. Richard Fogoros describes the problem: “Medicine is complex and nuanced. In the U.S., doctors attend four years of college, then four years of medical school, then three years of residency; most add another two or three (or more) years of subspecialty training before they're turned loose to practice medicine . . . . To expect patients to become sophisticated enough to do much more than accept the recommendations' of their highly trained doctors is inherently problematic.”—Richard M. Fogoros, M.D., Fixing American Healthcare, 2007, (Publish Or Perish DBS, Pittsburg), p. 217.

How is the problem solved? Dr. Fogoros goes on to say on page 301 of his book that, “Nobody knows what patient empowerment will actually look like because it hasn't been invented yet.”

The present invention empowers patients, doctors, nurses, and all healthcare providers. It will revolutionize healthcare once it is understood and utilized. It will provide true “product transparency” for the first time in medical history.

Top Studies

Methods of the present invention are used to establish the top 10, 20, 50, or even 100 most relevant and highest quality medical articles for any medical practice, and keep the database of studies updated. Each study is rated for overall quality, but also for relevance to the medical practice. Once the database of studies is established each new physician or other user who looks at that same clinical problem will not have to repeat that research all over again. The SOM system will create a database of the best medical research articles rated for quality and relevance (essentially a peer-reviewed database) of articles pertinent to each medical practice.

As an example of why this is needed follows: An inquiry about using a new antibiotic for a diagnosis was made. The three Drug Compendia that Medicare uses were all at least 2 years behind in evaluating the medical literature. The present invention would never be behind. All treatment and reimbursement decisions would be up to date and quantified.

Science of Medicine Score

Users are asked to review the peer-reviewed database of best medical articles for any given medical practice and give a Science of Medicine score for each medical practice (from 0 to 100). The Science of Medicine score is based on what the actual data (the hard science) says, and is the overall score for how good a treatment the doctor believes that treatment to be based on the scientific data. Note that each individual study that has enough data can be used to produce a SOM sore based on that one study, so that when the overall SOM score based on the entire collection of studies is given, it will be clear where the overall SOM score came from. The Science of Medicine score quantifies what is known, but just as importantly, it quantifies what is not known.

Medical Practitioner Clinical Experience Score

After the Science of Medicine score, medical practitioners who see these patients are next asked to also give a Clinical Experience score (CE score). For example, the Science of Medicine score (SOM score) may only be 10 for placing a cardiac stent for chronic stable angina, but the practicing cardiologist may say “I see my patients getting immediate relief,” so that cardiologist may give a CE score of 90 for that practice.

Patient Clinical Experience Score

The patients can also be asked to provide a CE score based on their experience with a procedure. Patient CE scores can be for different time periods, such as immediately after the procedure and then at later times and intervals.

Comparisons

A big difference between any of the scores reveals a problem. For example, there was a time when surgeons were reporting the frontal lobotomy to be 100% effective. Many poor quality studies supported that the frontal lobotomy was highly effective. However, the high quality studies said differently, but most patients and doctors had no idea. This system will point out and help to fix such discrepancies, because the differences between the SOM scores and the CE scores will be readily apparent. Where there is a large difference between the SOM score and the medical practitioner CE score and/or the patient CE score, there may be hype, perverse monetary incentives, bad science, or a powerful need to do more medical studies.

In addition, low SOM scores for any medical practice will point out that there are not enough high quality studies, and will help to direct, and prioritize, medical research.

Science of Medicine Essays

Besides the SOM score and the CE scores, the next most important product created by this system will be the Science of Medicine essays. Physicians will be asked to write review essays in support of their SOM scores and CE scores. These essays will be critiqued and rated and will be published. These essays will enable a new type of medical journal. SOM essays will teach medical statistics and critical thinking and they will be the most important form of continuing medical education yet devised. These essays essentially will continue the “Journal Club” education process, making it a lifelong endeavor for doctors. Journal Club will no longer be left behind in residency. These reviews are “doubly peer-reviewed,” because the articles on which the reviews are based will have been selected for quality and relevance by peer-review, and the written-up articles will also have been rated for quality by peer-review.

How Studies are Rated

Doctors are asked to rate the top studies from 0 to 100 for each clinical situation (both for relevance and quality). When this is done in blinded fashion, and then examine the quality and relevance ratings, there are sometimes very different lists of the “top studies” by different specialties of doctors. Each specialty tends to be indoctrinated by its “famous people” into believing the famous people instead of the data. This “authority bias” or “eminence bias” is too prevalent in medicine. “Commercial bias” comes into play as well. When it is in a specialty's financial interest to do a certain procedure, they are often more willing to accept poor quality, uncontrolled studies in support of their procedure. However, other experts reviewing the situation will clearly see this bias and will help to remove it from the final SOM Scores. There is also a “pharmaceutical bias,” where an industry may promote the literature they themselves funded, which our system helps to remove.

Double Peer Review

This process gives rise to what is call “double peer review.” First the studies are peer reviewed for quality and relevance to a medical practice, and then the review article based upon those studies is reviewed for quality and relevance. This way, through “double peer review” the best review articles based upon the best studies are ensured.

Triple Peer Review

The present invention also provides for a “triple peer review,” which is when the final review articles are rated against each other by professionals (or other experts) that are in the audience for that review article.

The essays will be produced as videos as well. Because of the Internet and cell phones, more and more people are using videos in preference to text.

Scoring Presentations

There are copious amounts of medical data that few can understand or compute. By using the 0-100 scoring system, this data can easily translate it into other formats. For example, letter grades can be assigned: one for each 20 percentiles in the positive range and F for anything with a negative SOM Score.

This gives scores of A, B, C, D, E, and F. Even with this rough focusing of the medical data, a vast improvement in understanding will occur.

Reimbursement

Finally, the SOM score (or the CE score in some cases) is tied to reimbursement. In this manner the more scientific medical practices are reimbursed at a higher rate. This will drive patients to the most scientific and cost effective treatments and consequently save lives and money. This solves the problem of how to distribute healthcare more efficiently, and reduces costs for all healthcare providers that use the system. Since healthcare is a trillion dollar industry, any improvement in distribution can amount to millions or billions of dollars saved.

List of Steps

The following are method steps according to the present invention:

Create a social network of physicians (and others)

Create lists of diagnoses and treatments (and all medical practices)

Organize the medical literature by quality and relevance

Produce the Science of Medicine scores

Produce the Clinical Experience scores

Use data to remove or point out biases

Utilize this system for Continuing Medical Education

Produce Science of Medicine review articles based on the scores

Produce Science of Medicine videos based upon the review articles

Produce Codes for billing, diagnosis, and treatment

Produce essays on how to prioritize research.

Conclusion

By quantifying the Science of Medicine several things are achieved: 1) patients are empowered by making medical care more transparent, 2) medicine is made more scientific by making the hard data more transparent, and by removing biases, and 3) the distribution of health care is improved by allowing healthcare providers a more objective way to reimburse healthcare.

How It Works in Detail

The SOM Score is far more sophisticated and valuable than any simple rating system now in existence. The algorithm uses demographic data to remove biases and the scores improve in accuracy the longer the database exists. Here is a partial list of techniques that are actually used by the Science of Medicine algorithm: co-intelligence, crowd wisdom, collective intelligence, the Delphi method, open-source medical algorithms, public domain tools, and artificial intelligence.

Techniques to remove biases and to point out when the experts are likely to be wrong or biased are disclosed herein. “Dashboards” are designed to point out these very issues and demonstrate the discrepancies and the likelihood of biases. Each end user can lay out their “dashboard” to discover what is in the data that is most important to them.

Techniques disclosed herein allow the user to obtain the most accurate quantification for the Science of Medicine Score behind medical practices. The end result is a rating or score that is easily understood by everyone—patients, laypersons, doctors, nurses, allied healthcare professionals, webmasters, insurance companies, Medicare, Medicaid, and reporters. The database is preferably updated daily in near real time by the SOM Network, taking into account every new medical study published almost as fast as they are published. Thus, the present invention quantifies and makes available to the user what everyone has always wanted to know: the inside medical information on what works—the knowledge that currently resides only inside the brains of our best physicians, nurses, other healthcare professionals, and sometimes the brightest and most experienced patients. This data can and will be displayed both together and separately as part of our process of removing biases and seeing problems never seen before.

Biases

The present invention removes biases and rate the raters. Every step of the process is rated. In this way each user of the database can pull out the data that is important to them. Perhaps a patient or third-party payer wants to compare how oncologists rate prostate cancer treatments compared to how urologists rate them. Perhaps they only want to see the ratings from the top 25% most highly rated physicians. They would be able to do all these things and more. The present invention rates the raters for their ratings and for their essays on the website and rates their biographies and institutions as well.

Individualized

Note that while the SOM Scores start out being for a general diagnosis and treatment, over time they can be individualized to each and every patient.

Website Dominance

There are currently thousands of websites competing on the Internet for medical traffic. These websites are all doing the same thing: writing reviews of the medical literature. What they are not able to do is produce what everyone really needs, the Science of Medicine Score behind medical practices—the most important piece of medical information. The website that accomplishes this will become dominant over time because the Science of Medicine Score is the essential inside information. Imagine that a man suffers an acute heart attack. He writes to the Science of Medicine social network with his laptop from his hospital bed and says, “I have been offered long-term medical therapy, angioplasty, or open heart surgery. What are the Science of Medicine Scores for these things?” The man would actually be able to get accurate answers. No other website would be able to compete with such a service. Imagine if patients could do this for any medical question they had.

Physicians do not currently agree on the Studies

One of the reasons that the Science of Medicine Scores are designed to remove biases is because different groups of physicians do not agree on the best studies for a given topic. In Journal Clubs, Mortality & Morbidity Conferences, in the comment and editorial sections of medical journals, and in the footnotes of review articles, you can see that the “experts” are not basing their thinking on the same studies. They often tend to cite the studies that support their already existing point of view. This is why the SOM algorithm rates studies for both quality and relevance for the clinical situation being scored. This will get everyone on the same page using the highest quality and most relevant studies for their decision-making.

Most people will be surprised to learn that the majority of the medical practices are not grade A. Most medical practices are probably only grade C or below when one actually looks at the hard data behind them. This system will point out research that badly needs to be done.

Perhaps the A to F grading is all the precision that third-party payers would need for most payment decisions, since they are not necessarily making decisions on what to do, but only on how to reimburse at different levels for less effective therapy.

Grade A—80%

Grade B—75%

Grade C—70%

Grade D—65%

Grade E—60%

Grade F—0%

The present invention further provides for Insurance Companies and Government Healthcare programs adjusted their co-payments according to the grading of a procedure according to the present invention. Any change in reimbursement based upon science would help steer patients toward the best, most cost-effective care. This knowledge would get all parties talking about the Science of Medicine behind medical practices. This would also make providers of care do better studies to try to get their reimbursement rates up for medical practices that do indeed work, or would push them to innovate where treatments do not work well.

Growth

Over time the Science of Medicine social network will be expanded. Doctors from around the world, nurses, dentists, pharmacists, and, in fact, all allied healthcare professionals can be included. Also, scientists, mathematicians, patients and laypersons can be included. This will add to the ability to remove biases from the Science of Medicine Scores.

Journal Club

It is necessary to emphasize how important the Science of Medicine Journal Club would be for physicians. It is frustrating to have to make a serious clinical decision at the bedside when there is incomplete data upon which to make that decision. Physicians do not want to practice guesswork with people's lives; doctors want to practice science. The same frustrations are experienced throughout their careers. When the consultants come to the Emergency Room for emergencies to admit the patients, there are many questions for which there is no quantification of the data. Physicians all have the same problem: they never really know what they do know or do not know. The data has never organized enough, or available enough for them, because it has not been quantified.

Who should be in the Social Network?

The SOM social network is preferably open to everyone who wants to be in it: All the passionate people from all over the world who want to help someone or help themselves—the people for which this information is literally of life and death importance. Our rating systems will allow those who love science and know science the best to rise to the top.

### Example 1

The following example is a real life situation that exists today in medicine and has been made non-specific. Numbers are rounded to make the calculations easy to visualize. In this scenario the treatments are mutually exclusive; they cannot be combined.

TABLE 1
Example of Science of Medicine score and cost for
different treatments for a hypothetical cancer x.

| Treatment for Cancer X | Science of Medicine Score | Cost |
|---|---|---|
| Chemotherapy | −10 | $30,000 |
| Surgery | 5 | $50,000 |
| Cryosurgery | 9 | $12,000 |
| Hormone therapy | 9 | $36,000 |
| External beam radiation | 9 | $20,000 |
| Brachytherapy (seeds) | 10 | $15,000 |

In our example, chemotherapy is actually harmful for Cancer X and should not be used—chemotherapy has a negative Science of Medicine Score. Surgery only gets a Science of Medicine Score of 5, which is very low. Yet, in the real world today, surgery is being hyped as being 90% effective for the actual Cancer X situation being used as an example.

Misleading advertising occurs in modern medicine. This is why removing physician bias is so important. The present invention creates the ability for one specialty of medicine to police the logic of any other specialty. This is why the most rational reviewers of data will have greater influence over time.

Note that if this product information were known, it would shift patients' actions, especially patients paying out of pocket, toward the two most cost-effective treatments in this hypothetical scenario, which are brachytherapy and cryosurgery. Importantly, patients' choices would not be curtailed; they could still undergo any treatment with a positive score. Any new treatments, or alternative treatments, could immediately be added to the database.

Patients would simply pay more for personal preferences that are less scientific, depending on how the Science of Medicine Score is tied to reimbursement. This will keep innovation alive for all the options. The present invention makes the best treatments known, and enables reimbursement to be tied to scientific effectiveness. The present invention will fix a “great wrong” that is occurring today where hype and marketing frequently lead to the use of the least effective, most expensive tests and treatments.

Once quantified, the Science of Medicine Scores can be used for treatment decisions, informed consent, education, reimbursement, and to advance specific deficiencies in medical research.

### Example 2

### Dashboard Example for Rating One Study

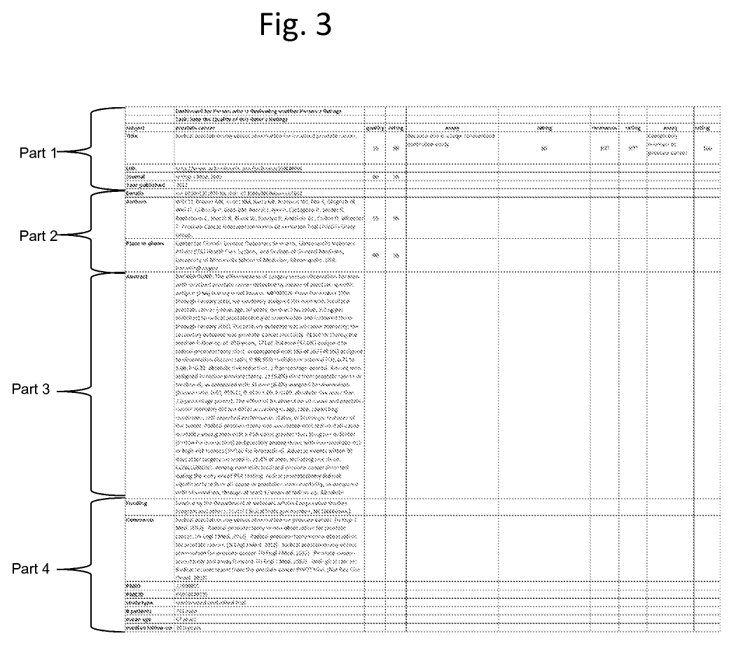

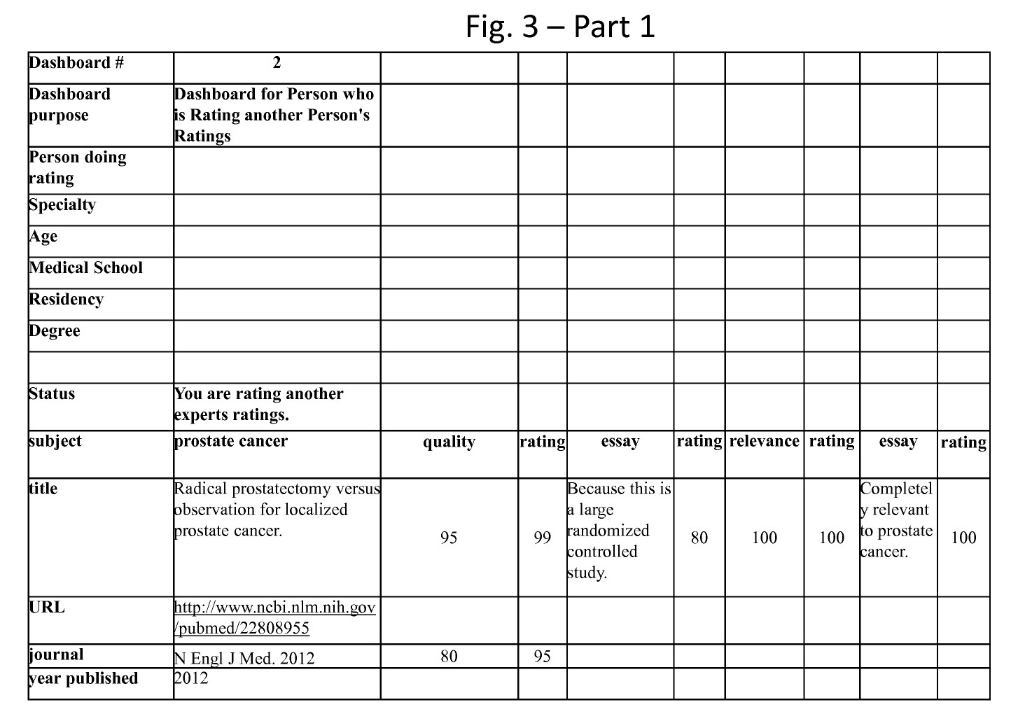

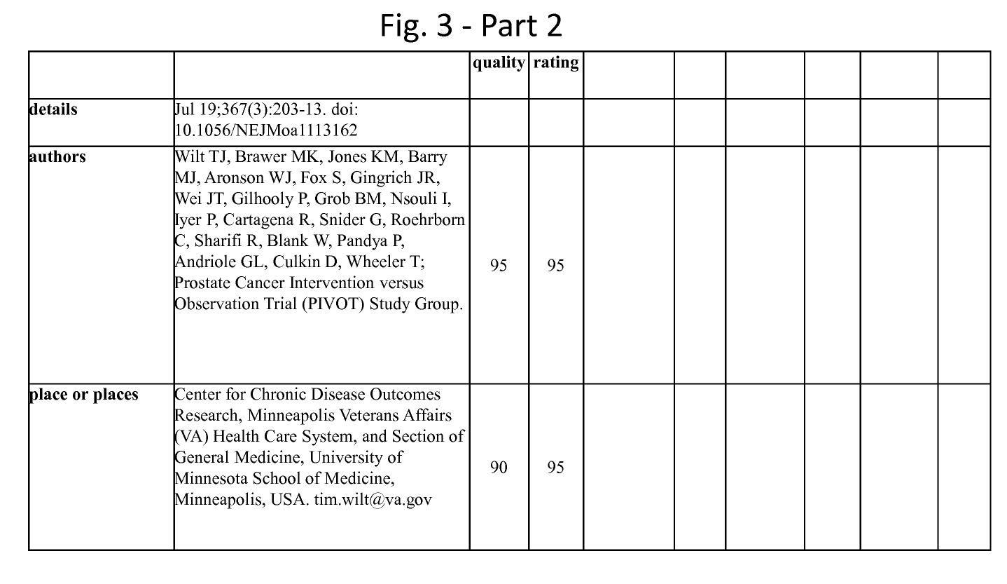

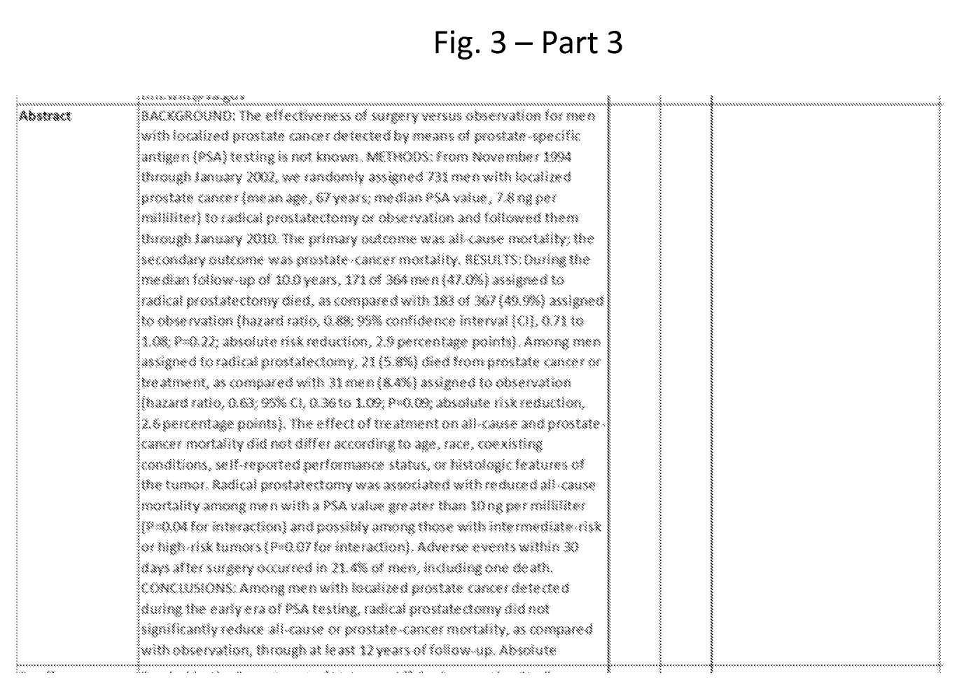

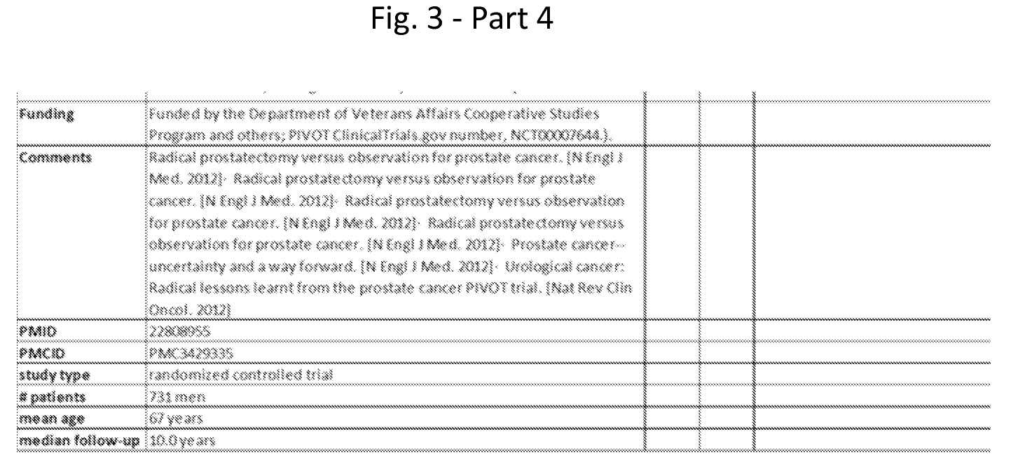

An example of a working dashboard for a user to review another user's ratings of a medical study is shown in FIG. 3. In this example, the technique of radical prostatectomy for localized prostate cancer as compared to observation was reviewed. In this example, the ratings of the first reviewer of the study and the second reviewer's ratings of the first review are shown. The study, publication journal, study authors and study location were evaluated. The essay was also evaluated.

### Example 3

### Surgery for Localized Prostate Cancer

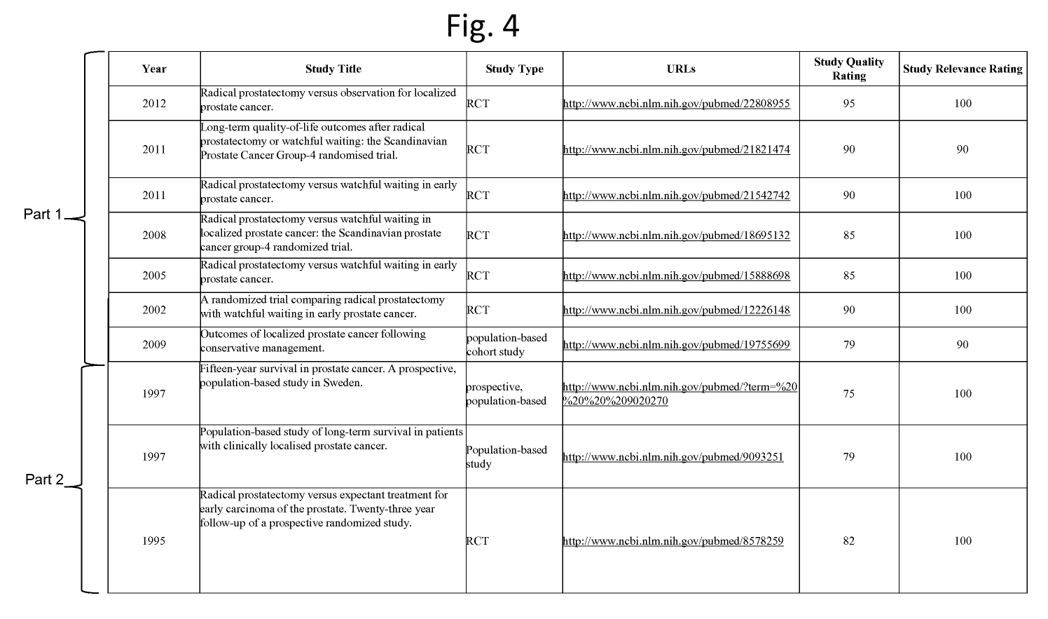

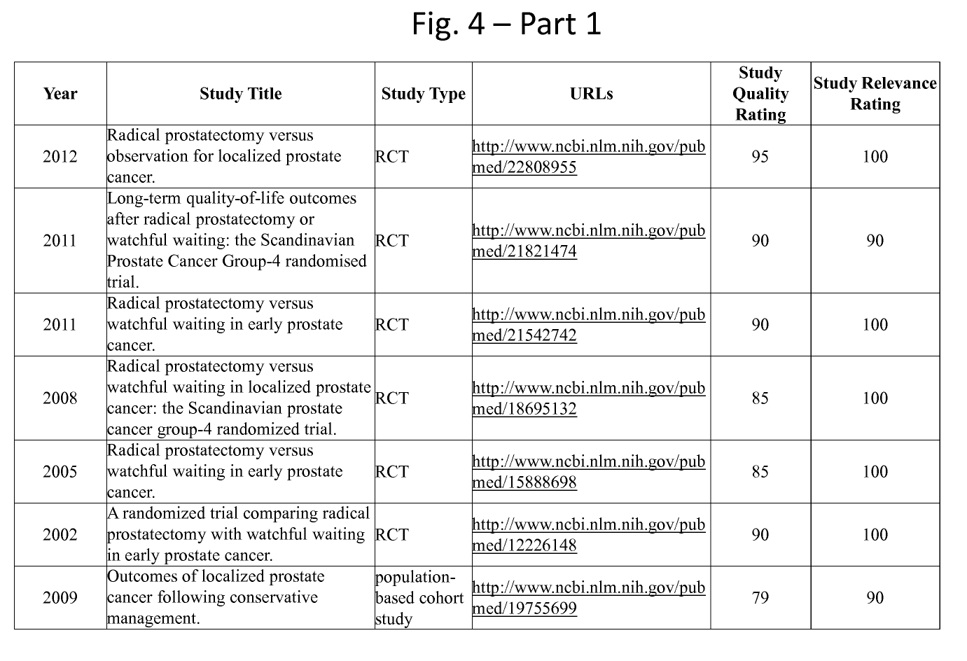

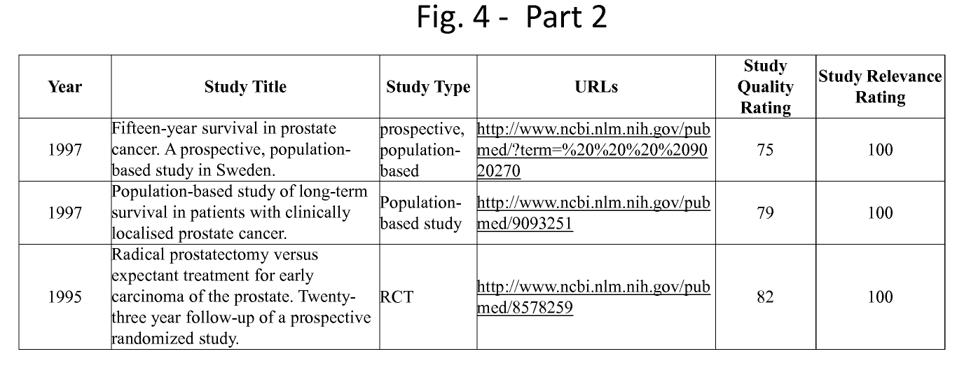

Some of the medical studies regarding surgery for localized prostate cancer are shown organized in FIG. 4. These are organized by putting the randomized controlled studies at the top, and also included several large population-based studies. Imagine how much time it would save everyone if such an organized database already existed for all our clinical scenarios.

### Example 4

### Science of Medicine Score

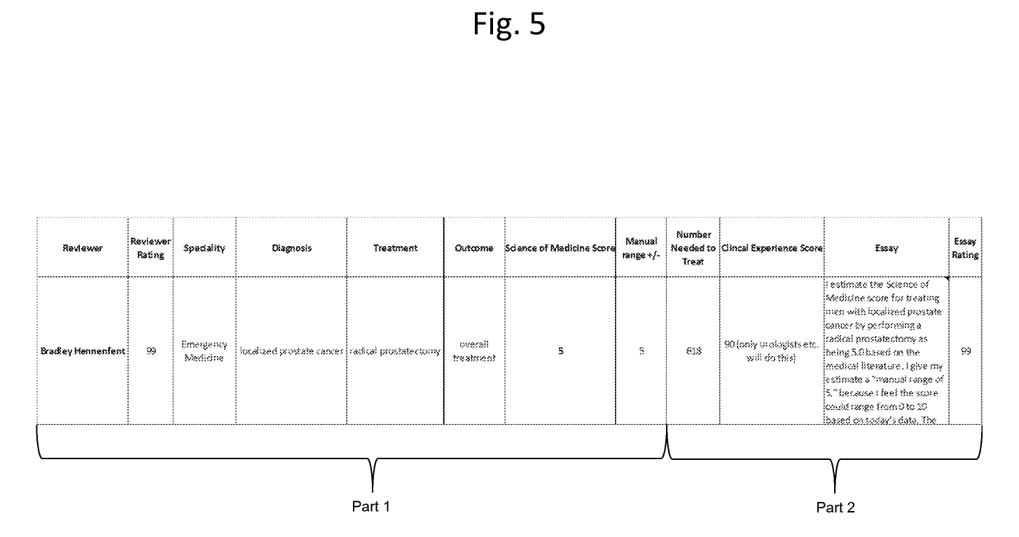

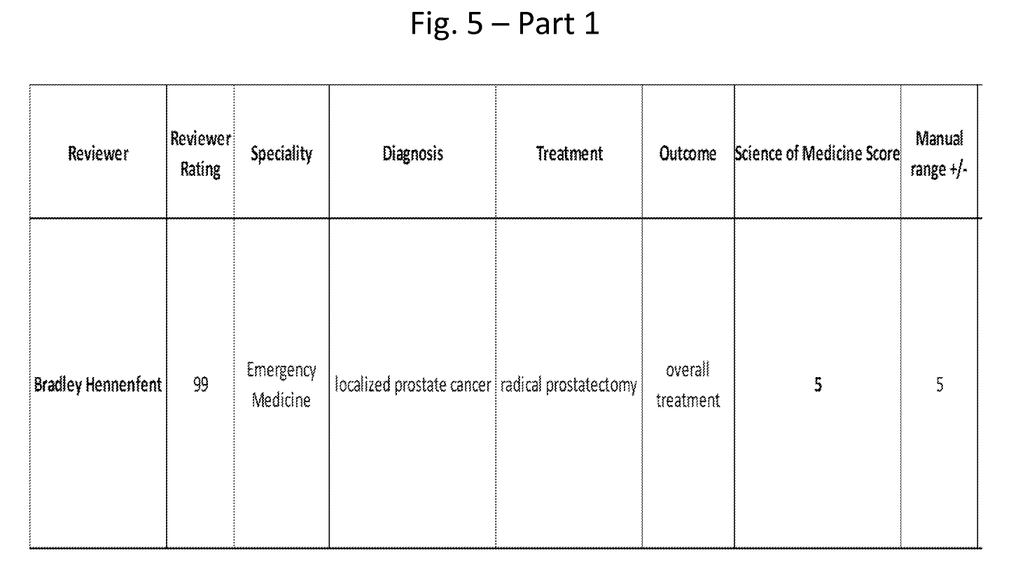

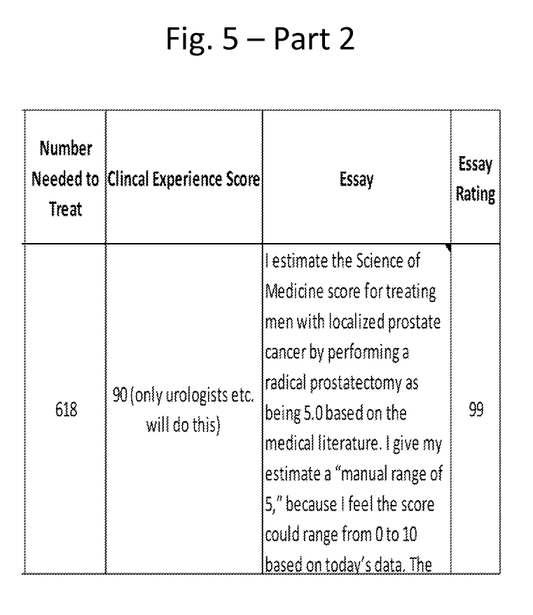

The determined Science of Medicine Score for doing a radical prostatectomy on localized prostate cancer is shown in FIG. 5. This demonstrates the need for Science of Medicine Scores. The SOM Score for this operation is only 5, however most people believe it is nearly 100. Experts actually routinely tell patients this surgery is 80 to 100 curative. Just by looking at the “Number Needed to Treat” which is 618 one should be very surprised. This means that 618 men need to be treated to benefit one man. That's dismal. Anyone with a statistics background can see that there is a serious problem in treatment efficacy.

### Example 5

### Surgery for Localized Prostate Cancer

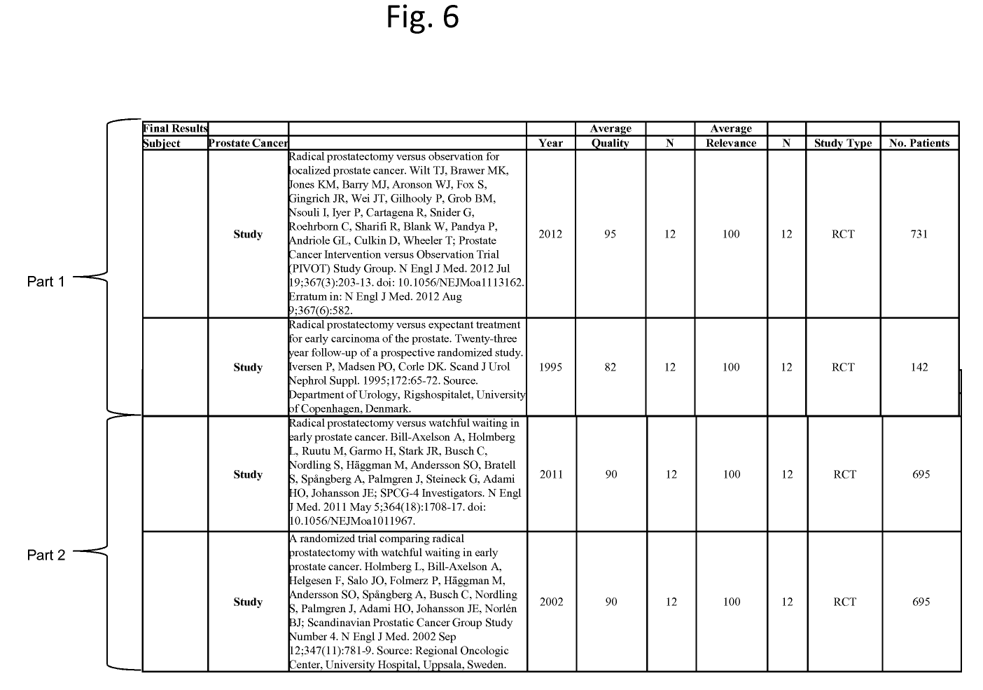

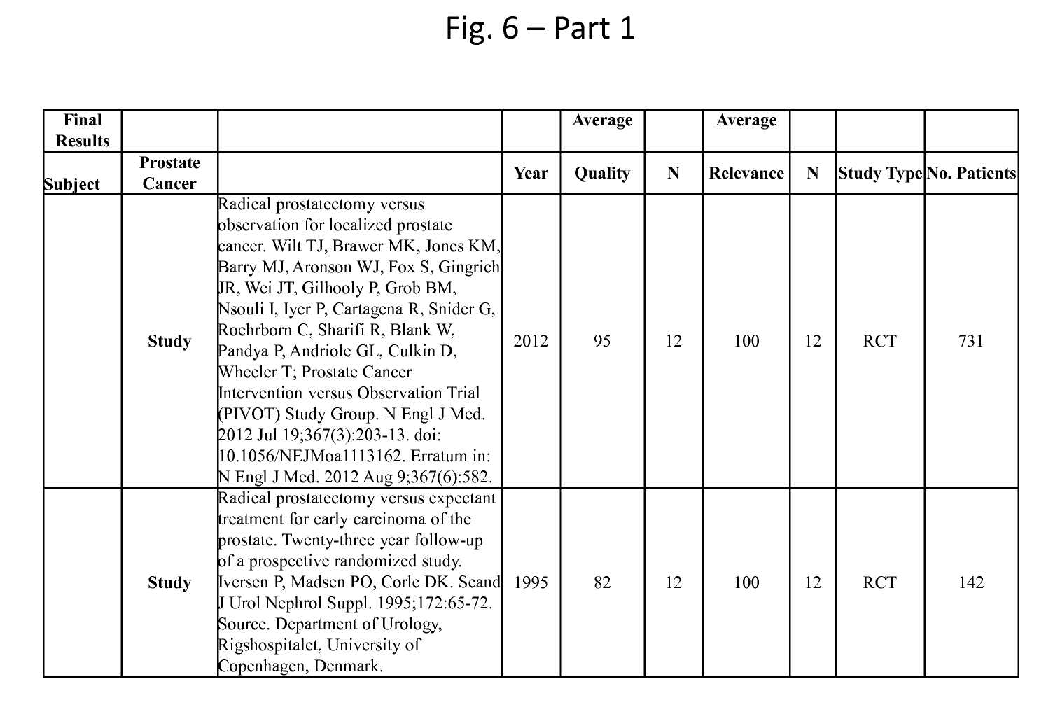

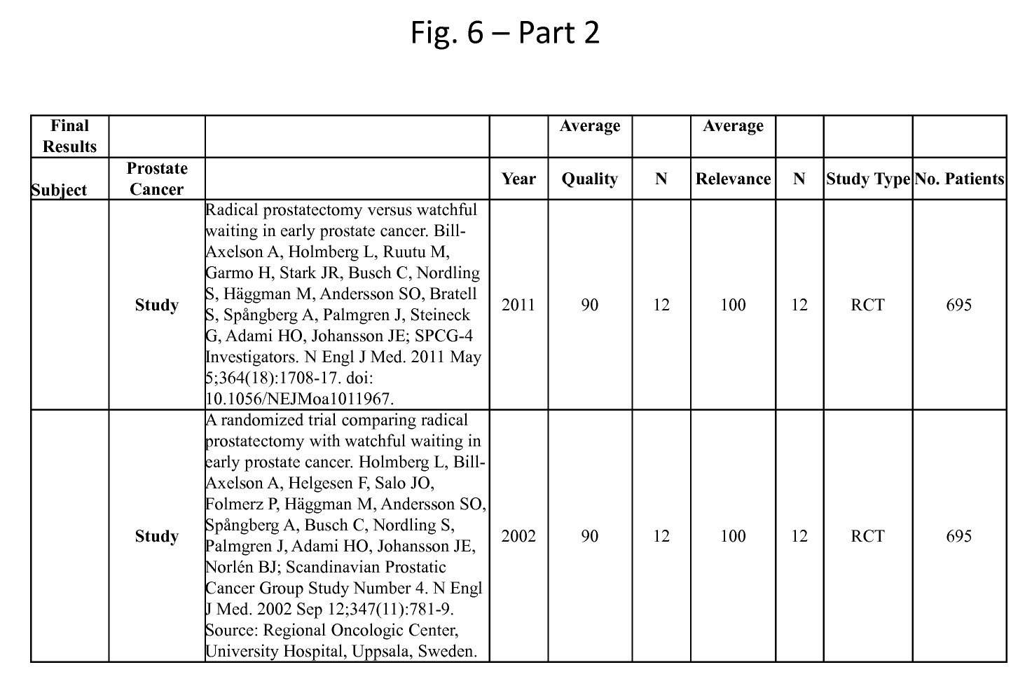

Another example dashboard for evaluating studies is shown in FIG. 6. This dashboard shows the studies for a particular procedure, the study year, the average quality of the study, the number of quality reviewers, the average relevance of the study to the subject, the number of relevance reviewers, the study type and the number of patients.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method for evaluating medical procedures, practices and/or diagnoses, the method steps comprising:
providing a network-based computer system including at least one server computer in communication with a multiplicity of remote devices providing access to data stored within the at least one server computer, wherein the at least one server computer is operable with software active thereon for performing the remaining steps:
receiving a selection of a medical procedure, practice, and/or diagnosis;
identifying best practices from a database of peer-reviewed medical information relating to the selection, wherein the medical information includes qualitative medical information and quantitative medical information;
transforming all qualitative medical information into a first quantitative value that corresponds uniquely to the medical procedure, practice, and/or diagnosis;
providing a final quantitative value for each medical procedure, practice, and/or diagnosis automatically generated from a combination of the first quantitative value and any other quantitative medical information relevant to the medical procedure, practice, and/or diagnosis;
communicating the final quantitative values to the users of a social network;
receiving clinical experience (CE) scores for each medical procedure, practice, and/or diagnosis from the users of the social network;
transforming the CE scores into a final clinical experience score for each medical procedure, practice, and/or diagnosis;
communicating the final CE scores to the users of the social network; and
thereby providing a benchmark for best practices for a specific medical procedure, practice, and/or diagnosis.

2. The method of claim 1, further including the step of generating a final medical practitioner CE score from CE inputs of medical practitioners

3. The method of claim 1, further including the step of generating a final patient CE score from CE inputs of patients.

4. The method of claim 1, further including the step of generating a final CE score from CE inputs of medical practitioners and patients.

5. The method of claim 4, further including the step of transforming the final CE score and the final quantitative value into a final combined score.

6. The method of claim 5, wherein the final combined score is based upon a scale of zero to 100.

7. The method of claim 6, further including the step of using the final combined value as a treatment code for automatic comparison to a benchmark value.

8. A system for providing automated rating of the science of medicine comprising a network-based computer system including at least one server computer in communication with a multiplicity of remote devices providing access to data stored within the at least one server computer, wherein the at least one server computer is operable with software active thereon, the software transforming qualitative and quantitative information on medical procedures to a unique quantitative science of medicine (SOM) rating and the software transforming clinical experience (CE) scores on medical procedures into a CE score.

9. The system of claim 8, further including online, remote access for authorized medical practitioner users and patients for initiating an inquiry into the remote server(s) database or repository of SOM ratings and CE scores for a predetermined listing of medical procedures, practices, diagnoses, and combinations thereof.

10. The system of claim 8, wherein the CE scores are scores by a social network of medical practitioners, patients and combinations thereof.

11. The system of claim 9, wherein the ranking by a social network is based upon their clinical experience includes inputs within less than about two years prior to the inquiry.

12. The system of claim 9, wherein the ranking by a social network is based upon their clinical experience includes inputs within less than about one year prior to the inquiry.

13. The system of claim 9, wherein the ranking by a social network is based upon their clinical experience includes inputs in near real time from the inquiry.

14. The system of claim 8, wherein the SOM rating is selected from SOM codes, percentages, ranking, and combinations thereof

15. The system of claim 8, wherein the system outputs an answer in response to an inquiry by a remote user accessing the system, the answer including automatically generated a listing of best practice(s).

16. The system of claim 14, wherein the listing of best practice(s) is provided in a ranked order from best or highest quantitative value to lowest.
